(19) United States
(12) Patent Application Publication
(10) Pub. No.: US 2010/0233977 A1
(43) Pub. Date: Sep. 16, 2010

(54) MULTI-MODE RADIO TRANSMITTERS AND A METHOD OF THEIR OPERATION

(75) Inventors: Brian J. Minnis, Crawley (GB); Paul A. Moore, Seaford (GB)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/293,815

(22) PCT Filed: Mar. 26, 2007
(86) PCT No.: PCT/IB2007/051044

§ 371 Date: Sep. 20, 2008

(30) Foreign Application Priority Data
Mar. 30, 2006 (EP) 06112024.2

(51) Int. Cl. H04B 1/04

(52) U.S. Cl. 455/127.1

(57) ABSTRACT

A multi-mode radio transmitter for use in mobile radio cellular standards, such as 2G, 2.5G and 3G, and a method of operating the transmitter in which an input signal is modulated independently of controlling the drive of a power amplifier (PA) module (40). The transmitter comprises circuitry (12, 60) for extracting the phase (θ) and amplitude (R) components from envelope information in the input signal. A modulator (110) uses the phase component (θ) to produce a constant-envelope signal comprising a phase modulated real signal at the transmitter frequency. This signal is multiplied in a multiplier (72) with either a fixed bias voltage (V_{g1}) to produce a constant envelope signal or a low level envelope tracking signal derived from an amplitude component (R) by a first amplitude control circuit (78) to produce a signal modulated exactly by the amplitude component. An output from the multiplier is applied to the PA module (40) having a control input (41). The PA module is controllable in a plurality of manners dependent on the characteristics and the required output power of the signal being transmitted. These manners include applying a predetermined fixed voltage to the control input or a less precise envelope tracking signal which is derived by a second amplitude control circuit (120) from the amplitude component (R).

### TECHNICAL

The present invention relates to multi-mode radio transmitters and to a method of operating such transmitters. The invention has particular, but not exclusive, application to hybrid polar radio transmitters.

### BACKGROUND ART

One of the key drivers in determining what constitutes the best architecture for a radio transmitter, especially for battery-powered applications, is the achievement of high power efficiency.

The Global System for Mobile Communications (GSM) is a second-generation (2G) cellular radio standard that uses constant-envelope modulation. It is therefore comparatively easy to achieve a high power efficiency in the transmitter of handsets targeted at this standard, as the power amplifier (PA) can be operated in saturation. Operating the PA in saturation has established a benchmark for power efficiency that the market expects to be maintained in products targeted at more advanced cellular radio standards than GSM.

Third-generation (3G) cellular radio standards, such as Code Division Multiple Access 2000 (CDMA2000) and the Universal Mobile Telecommunication System (UMTS), as well as transitional (2.5G) standards, such as Enhanced Data Rates for GSM Evolution (EDGE), all use non-constant-envelope modulation schemes. Standard architectures for the transmitter of handsets targeted at these applications necessarily operate the PA linearly, and this makes it difficult to achieve a power efficiency that looks attractive.

Three different techniques can be considered in the quest to improve the power efficiency of transmitters for handsets targeted at cellular radio standards that use non-constant-envelope modulation. Efficiency control involves adjusting the power supply voltage to the PA in accordance with the average RF output power that is being demanded. This improves the power efficiency at lower than the maximum RF output power by eliminating headroom when it is not needed. Since the rate at which the average RF output power can be changed is usually limited, efficiency control can almost always be applied. Envelope tracking extends this principle by adjusting the power supply voltage to the PA in accordance with the instantaneous RF output power that is being demanded by the modulation. This further improves the power efficiency, even at the maximum RF output power, but puts greater demands on the system, especially in those parts associated with the PA power supply, as the rate at which the instantaneous RF output power changes depends on the bandwidth of the amplitude component of the modulation. This bandwidth can be up to a factor of 10 greater than that of the baseband representation of the modulation. However, as the degree to which the supply track is made to follow the envelope of the modulation is a matter of choice in the case of envelope tracking, the approach is feasible for most of the current cellular radio standards and only becomes impracticable for standards that use an extremely wide bandwidth. Polar modulation looks superficially similar to envelope tracking but pushes the principle one stage further by operating the PA in saturation. The PA is driven by a constant-envelope RF input signal that contains only the phase component of the modulation, and adjusting the power supply voltage to the PA in accordance with the instantaneous RF output power being demanded then re-instates the amplitude component of the modulation, at high level, in the PA. This achieves the highest power efficiency, but puts even greater demands on the transmitter system, as timing issues become more severe, and the PA no longer offers any rejection of noise on its power supply. Polar modulation is therefore generally more difficult to implement than envelope tracking, especially for the wide-bandwidth standards.

FIG. 1 of the accompanying drawings is a block schematic diagram of a hybrid Cartesian/polar transmitter architecture disclosed and claimed in unpublished European Patent Application EP 05100721.9. The architecture disclosed is able to support efficiency control, envelope tracking, and polar modulation.

Referring to FIG. 1, the transmitter illustrated comprises a modulator 100 having an input 102 for data, an input 104 for a carrier signal generated by a carrier generator 38, a first output 106 for delivering the carrier signal modulated by the data, and a second output 108 for delivering a power supply control signal. The first output 106 of the modulator 100 is coupled to an input of a power amplifier (PA) 40 for amplifying the modulated carrier signal and for supplying the amplified and modulated carrier signal on an output 42 for coupling to an antenna (not illustrated). The second output 108 of the modulator 100 is coupled to a control input of a DC power supply 44, which may be for example a DC/DC converter. The DC power supply 44 provides a DC supply voltage that is coupled to supply the PA 40 with power. The DC supply voltage is dependent on the power supply control signal present at the second output 108. In the case of GSM which uses constant envelope modulation the power supply control voltage will be a function of the average power and will be substantially DC during the burst specified.

A modulator control means 58 controls a quadrature generation means 110 and a power supply control means 120. A primary function of the modulator control means 58 is to set the desired average output power level of the PA 40.

The quadrature generation means 110 generates, at baseband, quadrature related signal components, i.e. an in-phase component (I) and a quadrature phase component (Q), from the input data. The quadrature generation means 110 comprises a quadrature generator 12, 14, for generating, in the digital domain, the baseband I and Q components from the input data. The baseband signal path of the quadrature generation means 110 comprises digital-to-analogue (DAC) converters 22, 24 for converting the I and Q signal components from the digital to analogue domain, filters 26, 28 for filtering the analogue I and Q signal components and amplifiers 30, 32. The DACs 22, 24 may be coupled to the modulator control means 58 as DAC parameters, such as offset voltage, and scaling the maximum output of the DACs 22, 24 may depend on the control exerted by the modulator control means 58.

Optionally, predistortion means 18, 20 for predistorting the I and Q components may be included to compensate for distortion introduced by modulator 100 elements or by other elements of the transmitter. Such predistortion means 18, 20 may be coupled to the modulator control means 58 as the predistortion required may depend on the control exerted by the modulator control means 58, particularly the average output power of the transmitter.

The modulator 100 further comprises a quadrature modulation means 34 which modulates the carrier by mixing the I and Q signal components from the amplifiers 30, 32 with respective quadrature related components of the carrier signal and delivers the combined components on the first output 106. In particular, the quadrature generation means 110 is adapted to generate I and Q signal components for a modulation scheme that, on transmission, has a non-constant envelope carrier signal, such as required for example for UMTS.

In its basic form as described so far, the modulator 100 is used with a PA 40 that does not saturate but remains linear throughout its operating range. In order to control the average output power of such a non-saturating PA 40, for example as required for closed loop power control in a cellular mobile communication system, the modulator control means 58 controls the amplitude of the I and Q signal components delivered by the quadrature generation means 110. FIG. 1 illustrates one way of doing this in which the modulator control means 58 controls the gain of the amplifiers 30, 32 in the path of the I and Q signal components, respectively, and scales the maximum output of the DACs 22, 24. However, the amplitude of the I and Q signal components may be controlled at other points in the baseband signal path of the quadrature generation means 110.

The modulator 100 further comprises a power supply control means 120 for generating the power supply control signal at the second output 108. The power supply control means 120 has an input coupled to receive signals from the quadrature generation means 110. In particular, the power supply control means 120 is adapted to generate a power supply control signal that tracks the envelope of the modulated carrier signal appearing at the first output 106. Envelope tracking in this way enables power efficiency to be improved by ensuring that, as the carrier signal envelope fluctuates, the DC supply voltage is maintained at the minimum level required for the PA 40 to accurately amplify the fluctuations.

The power supply control means 120 comprises generation means 46 for generating the power supply control signal from the baseband I and Q signal components. To facilitate this, it may be convenient to extract the baseband I and Q signal components from the quadrature generator 12, 14 before completion of all the required baseband processing on the I and Q components, as denoted by separate processing elements 12 and 14.

The power supply control signal is scaled by a scaling means 48 which is coupled to the modulator control means 58 for control of the extent of scaling and control of DC offset.

Optionally, a predistortion means 50 for predistorting the power supply control signal may be included to compensate for distortion introduced by modulator 100 elements or by other elements of the transmitter. Such predistortion means 50 may be coupled to the modulator control means 58 as the predistortion required may depend on the control exerted by the modulator control means 58.

The power supply control signal path of the power supply control means 120 comprises a DAC 52 for converting the power supply control signal from the digital to analogue domain, and a filter 54 for filtering the analogue power supply control signal. The DAC 52 may be coupled to the modulator control means 58 as DAC parameters, such as offset voltage, and scaling of the maximum output of the DAC 52 may depend on the control exerted by the modulator control means 58. The power supply control signal path further includes a buffer amplifier 56 for driving the DC power supply 44.

It is also possible for the transmitter shown in FIG. 1 to do polar modulation with a saturated PA 40.

A key feature of the transmitter shown in FIG. 1 is that the PA is driven by an RF input signal that is generated by representing the modulation in Cartesian (I and Q) form, at zero-IF, and converting this complex signal into a real signal, at the required carrier frequency, using a vector modulator. However further investigation has shown that although this direct up-conversion approach facilitates providing power control over a wide dynamic range, as needed by the 3G standards, management of DC offsets, which lead to carrier leakage, turns out to be major overhead. Additionally the design of the low pass reconstruction filters 26, 28 and 54 has been found to be difficult with regard to signal handling and stability having regard to noise levels being generated, particularly in the final stage of the respective filters. In order to reduce the noise level the power consumption of these filters could be unacceptable. Further, the arrangement is, in itself, not very power efficient, due to the need for two mixers, with a very high dynamic range, in addition to the voltage-controlled oscillator (VCO).

### DISCLOSURE OF INVENTION

It is an object of the present invention to improve the power efficiency of radio transmitters capable of operating in constant envelope and non-constant envelope modes.

According to a first aspect of the present invention there is provided a method of operating a multi-mode transmitter in which an input signal is modulated independently of controlling the drive of a power amplifying means.

In implementing the method in accordance with the first aspect of the present invention the amplitude information is separated from phase information in the input signal to be transmitted. The phase information is used to produce a modulated constant envelope real signal at the frequency of the transmitter and the amplitude information is used to amplitude modulate the constant envelope signal. More particularly the amplitude modulation is applied in a selected one of two modes, in a first of the two modes the amplitude modulation is applied as a low level signal prior to power amplification in the power amplifying means operating in a linear envelope tracking mode in which an envelope tracking signal derived from the amplitude information is applied to the power amplifying means at high level and in a second of the two modes the constant envelope real signal is multiplied by a fixed voltage signal prior to being applied to the power amplifying means operating in a saturation mode and the amplitude modulation is applied to the power amplifying means at high level, the selection of the first or second of the two modes being dependent on the characteristics and required output power of the signal being transmitted.

According to a second aspect of the present invention there is provided a multi-mode transmitter comprising an input for an input signal, modulating means for producing a modulated signal, power amplifying (PA) means coupled to the modulating means, the PA means having a control voltage input, and means for providing a PA control voltage to be applied to the control voltage input independently of the modulating means.

In an embodiment of the multi-mode transmitter made in accordance with the second aspect of the present invention there is provided means for deriving separately phase (8) and amplitude (R) components present in an input signal, means for producing from the phase component information a modulated constant envelope real signal at the operating frequency of the transmitter, first means for producing from the amplitude (R) component information a first amplitude signal comprising a substantially faithful representation of the amplitude component of the input signal, multiplying means having a first input for the real signal and a second input coupled in a first optional condition to the first means for applying the first amplitude signal to effect amplitude modulation of the real signal for envelope tracking or in a second optional condition to means for setting the second input to a fixed voltage for polar modulation, the multiplying means having an output coupled to the power amplifying means, second means for producing a second amplitude signal from the amplitude (R) component information, a power control voltage generating means having a control input coupled to receive the second amplitude signal, the power control voltage generating means having an output coupled to the control input of the power amplifying means, said second means in the first optional condition providing a power control signal enabling envelope tracking to be applied to the power amplifying means working in a linear mode or in the second optional condition providing an optionally pre-distorted power control voltage for polar modulation when the power amplifying means is operating in saturation, and control means for controlling the first and second means to operate in the first optional condition for envelope tracking and a second optional condition for polar modulation dependent on the characteristics and required output power of the signal being transmitted.

In an embodiment of the present invention the low-level signal generation is based on a polar (R and Θ) approach, rather than on a Cartesian arrangement as shown in FIG. 1. However, as the desire to use envelope tracking still exists, in certain operational scenarios, two means for producing signals from the amplitude R component need to be present.

A phase locked loop may be used to produce the modulated constant envelope real signal. This has the advantage over the transmitter shown in FIG. 1 of not requiring the DACs 22, 24, low pass filters 26, 28 and the quadrature modulation means 34 comprising two mixers thereby avoiding the problems of carrier leakage, excessive power consumption in reducing the noise levels generated in the low pass filters and operating mixers having a high dynamic range.

A dual-point modulation arrangement may be used within the phased locked loop.

### BRIEF DESCRIPTION OF DRAWINGS

The present invention will now be described, by way of example only, with reference to the accompanying drawings, wherein:

FIG. 1 is a block schematic diagram of a transmitter described in EP 05199721.9,

FIG. 2 is a block schematic diagram of an embodiment of the present invention in which the transmitter is based on a polar approach,

FIG. 3 is a frequency plot of the frequency responses of the DC/DC converter (continuous line) and the linear regulator (broken lines) shown in FIG. 2,

FIGS. 4A to 7 are voltage waveform diagrams for operation in a large signal polar mode,

FIGS. 8A to 12 are voltage waveform diagrams for operation in small signal polar mode with envelope tracking, and

FIG. 13 is a block schematic diagram of an embodiment of the invention in which the transmitter is based on a Cartesian approach.

In the drawings the same reference numbers have been used to indicate corresponding features.

### MODES FOR CARRYING OUT THE INVENTION

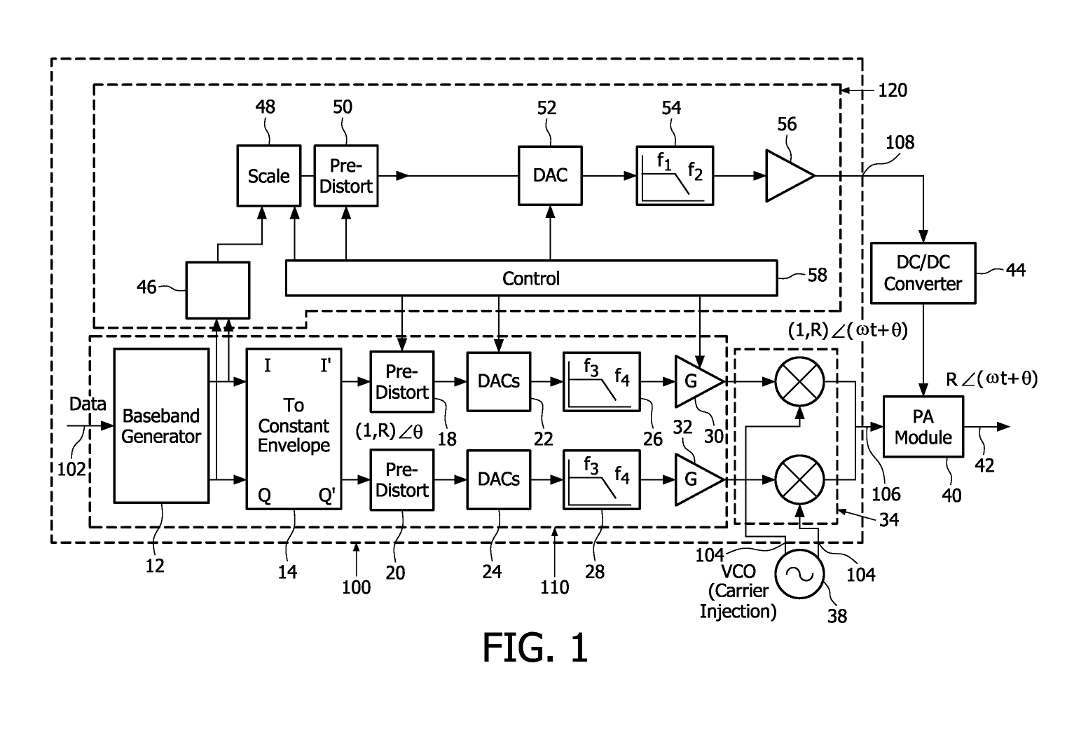

As FIG. 1 has been described in the preamble of this specification it will not be described again.

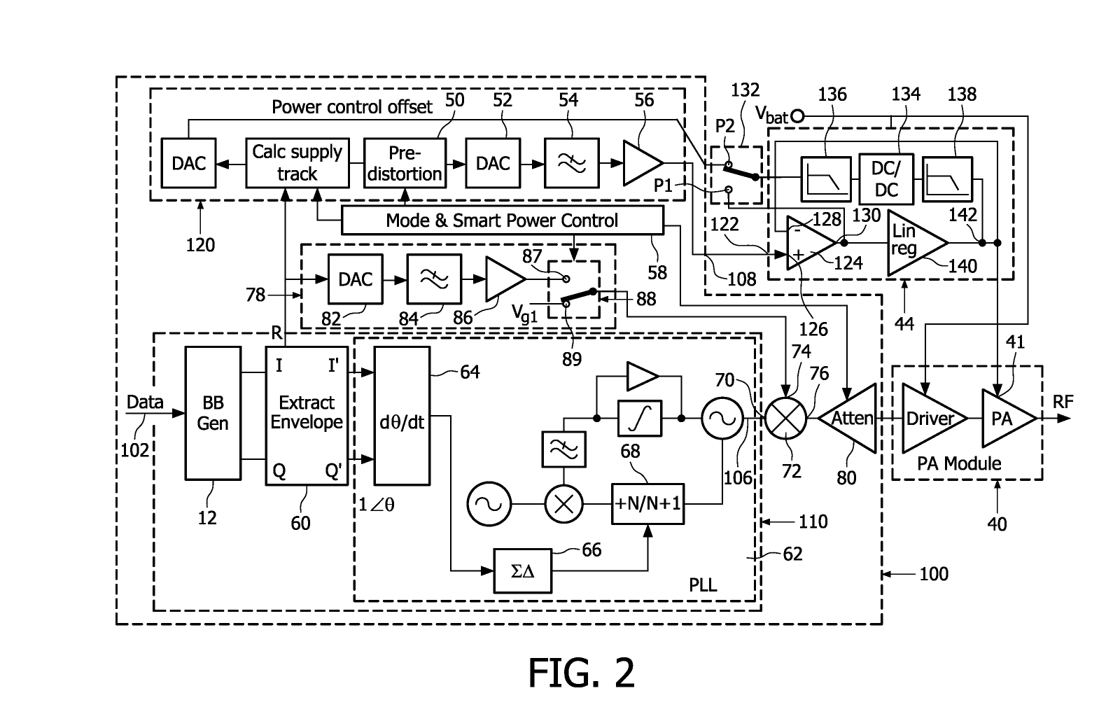

Referring to FIG. 2, the transmitter shown is a hybrid polar radio transmitter. The transmitter comprises a modulator 100, a power amplifier 40 having a control input 41, and a hybrid supply modulator 44 coupled to the control voltage input 41.

The modulator comprises a real signal generator 110 having a data input 102 and an output 106 for a real signal at the operating frequency of the transmitter. The data input 102 is coupled to a base band generator 12 which produces quadrature related I and Q signals. The I and Q signals are applied to an envelope extract block 60 which produces a constant envelope output containing just the phase component I′, Q′ of the modulation (for a constant radius) at all RF output power levels. This complex constant envelope output is converted into a real output signal, at the required carrier frequency, using a fractional-N phase locked loop (PLL) 62. A differentiating stage 64 determines the rate of change of phase and this is used by a Sigma-Delta modulator 66 to determine the division ratios (N/N+1). The output from the Sigma-Delta modulator 66 is coupled to the divider 68 in the PLL 62. In the interests of brevity the remainder of the PLL 62 will not be described in detail as its structure and operation are known in the art.

If desired a dual-point modulation arrangement may be used within the phase locked loop 62.

The output 106 of the real signal generator 110 is connected to a first input 70 of a multiplier 72, a second input 74 of which receives an output from a first amplitude component circuit 78. An attenuator 80 controlled by a modulator control circuit 58 is coupled to an output 76 of the multiplier 72. An output of the attenuator is coupled to a power amplifier (PA) module 40.

The first amplitude control circuit 78 has as an input, a digitised amplitude or radius component R extracted by the envelope extract block 60. The component R is converted into an analogue voltage by a digital-to-analogue converter (DAC) 82. The analogue voltage is filtered by a low pass filter 84 and the resulting signal is applied to a buffer amplifier 86. The output from the buffer amplifier 86 is the amplitude component of modulation and is applied to one pole 87 of a two-way switch 88 which is controlled by an output from the modulator control circuit 58. A fixed bias voltage V_{g1} is applied to another pole 89 of the two-way switch 88.

In operation, for envelope tracking with the PA operating linearly, the switch 88 is connected to pole 87 of the switch 88 so that a faithful representation of the amplitude component of the modulation R is supplied to the input 74 of the multiplier 72 where it is re-instated into the real signal on the first input 70 by the operation of the multiplier 72. Although this multiplier could also provide a degree of power control, it is envisaged that it will be better to keep this function separate from that of amplitude modulation, hence the reason for providing the attenuator 80 that follows. For polar modulation, with the PA 40 operating in saturation, the output of the PLL 62 is already the RF input signal required, so the second input to the multiplier is then set by the two-way switch 88 to the fixed voltage V_{g1}. In this mode of operation no attenuation is necessarily required.

A second amplitude control circuit 120 is provided for controlling a second amplitude component of the modulation R path which is provided for controlling the power supply voltage to the control input 41 of the PA module 40. As the second amplitude control circuit 120 is essentially the same as the circuit 120 described with reference to FIG. 1 it will not be re-described here. Its purpose is to generate a power supply control signal on the output 108 that can track less aggressively than the first amplitude control circuit 78 the envelope of the modulated carrier signal appearing on the output 76. It can also re-modulate the amplitude component, when the PA 40 is operating in saturation.

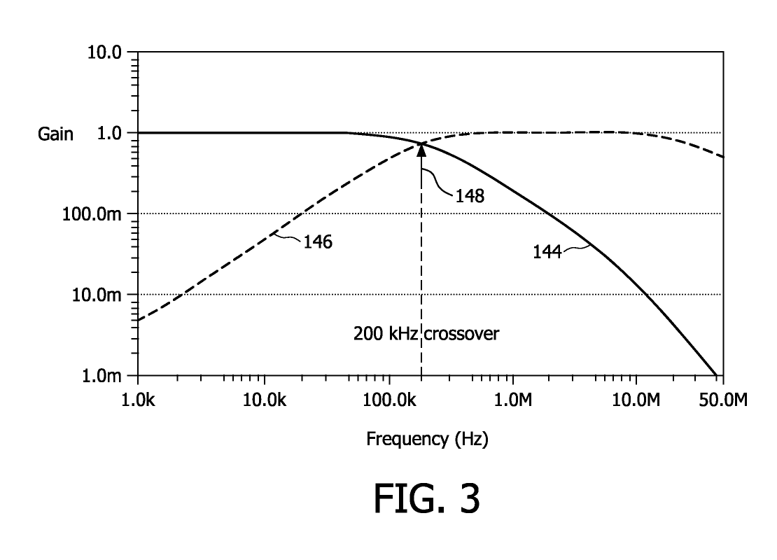

The hybrid supply modulator 44 comprises an input connected to the output 108 of the second amplitude control circuit 120. A summing amplifier 124 has a non-inverting input 126 coupled to the input 122 and an inverting input 128. An output 130 of the amplifier 124 is coupled by way of a switch 132 to a low pass filter 136, an output of which is coupled to a DC/DC converter 134. The filter 136 is responsible for the frequency response of the DC/DC converter 134, as shown in FIG. 3. A ripple filter 138, implemented as a low pass filter, is connected to the output of the DC/DC converter 134. A linear regulator 140 has an input coupled to the output 130 of the amplifier 124. A junction 142 formed by the outputs of the ripple filter 138 and the linear regulator 140 is coupled to both the control input 41 of the PA module 40 and the inverting input 128 of the amplifier 124. The coupling from the junction 142 to the inverting input 128 forms a feedback loop which serves for suppressing ripple and also presents a low output impedance to the control input 41.

The switch 132 is a change-over switch which in one position P1 connects the DC/DC converter 134 in parallel with the linear regulator 140 and in a second position P2 connects a power control offset signal derived from the second amplitude control circuit 120 to the DC/DC converter 134.

For both polar modulation and envelope tracking, the switch 132 is coupled to position P1 so that the DC/DC converter 134 and linear regulator 140 operate essentially in parallel. In a variant, for polar modulation, the DC/DC converter may be operated independently by connecting the switch 132 to the position P2 so that the DC/DC converter 134 derives its input from a separate voltage reference source in the second amplitude control circuit 120 delivering only the DC component of the modulation supplied to the PA module 40.

The hybrid supply modulator 44 is capable of supplying the required control voltage to the PA module 40 over a bandwidth of 0 to 50 MHz. By the action of the feedback loop between the junction 142 and the inverting input 128 of the amplifier 124, the DC/DC converter supplies most of the control voltage to the control input 41 of the PA module 40 at frequencies below 200 kHz and the linear regulator supplies most of the control voltage at frequencies above 200 kHz. This is illustrated in the simple frequency plot shown in FIG. 3 in which the continuous line 144 represents the characteristic of the DC/DC converter 134, the broken line 146 represents the characteristic of the linear regulator 140 and the reference arrow 148 represents crossover at 200 kHz. As shown the DC/DC converter 134 cuts-off at 50 MHz. The DC/DC converter 134 handles the majority of the power contained in the envelope signal being supplied to the PA module 40 and the linear regulator 140 supplies a small, although essential, fraction of the power. In the case of EDGE, 99% of the power in the envelope signal is contained in the frequencies below 200 kHz whereas for UMTS the figure is 96%. However, in both cases, most of this power is DC.

Whilst the first amplitude control circuit 78 only ever has to provide a faithful representation of the amplitude component of the modulation, this is not true for the second amplitude control circuit 120. For envelope tracking, an appropriate degree of scaling and offset has to be applied, to keep the PA working at a constant degree of (minimal) gain compression, and prevent its RF output from collapsing at very low power supply voltages. For polar modulation, pre-distortion may need to be applied, to compensate for any lack of linearity in the amplitude modulation characteristics of the PA. It is therefore not possible to combine the functions of the first and second amplitude control circuits into one.

It is not currently possible to use the DC/DC converter to adjust the power supply voltage to the PA module 40, when this is operating in saturation, as even a state-of-the-art device is too noisy to allow typical type approval specifications to be met. Only the linear modulator 140 can be used in these circumstances. As a result, polar modulation only provides the high power efficiency that one would expect from it at RF output power levels that are close to the maximum. At lower levels, the comparatively poor power efficiency of the linear regulator, when operating alone, rapidly degrades the overall performance. By contrast, at lower RF output power levels, envelope tracking provides a higher level of performance, despite the intrinsically poorer power efficiency of the PA module 40, when operating linearly, as this is more than offset by the improvement in power efficiency that is made possible by the DC/DC converter 134 being brought into play. One of the great strengths of this architecture is its ability to move from using one technique for improving power efficiency to another, at different RF output power levels. The presence of the attenuator 80 after the multiplier 72 helps in achieving such transitions in as seamless a manner as possible.

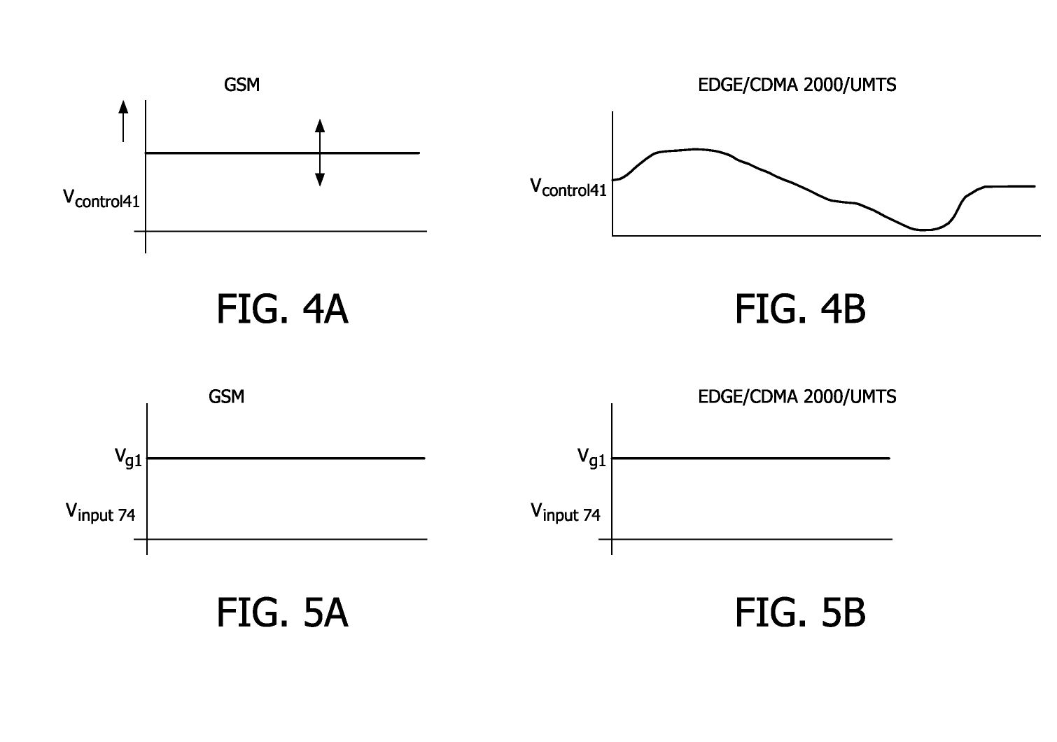

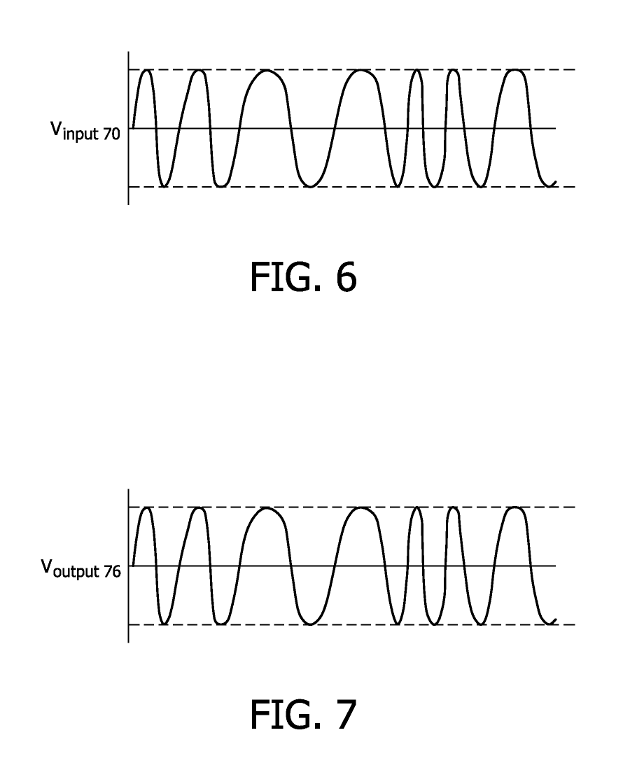

Reference will now be made to FIGS. 4A to 7 and FIGS. 8A to 12 which illustrate, respectively, large signal polar and small signal polar with envelope tracking modes of operation. The GSM constant envelope modulation is contrasted with the non-constant envelope modulations of EDGE, CDMA 2000 and UMTS. For convenience of reference in the following description the term “non-GSM” will be used when referring collectively to EDGE, CDMA 2000 and UMTS. FIGS. 4A and 4B respectively illustrate the voltages at the control input 41 of the PA module 40 for GSM and non-GSM modulations. In the case of FIG. 4A the voltage is a DC voltage the value of which is a function of the average power whereas in FIG. 4B the voltage, which is also a function of the average power, varies generally with the amplitude component of the modulating signal. The voltage illustrated in FIG. 4B is derived by the second amplitude control circuit 120. FIGS. 5A and 5B illustrate that, for large signal polar modulation with GSM and non-GSM modulations, the voltage on the second input 74 of the multiplier 72 is a DC voltage having a value V_{g1}, the switch 88 having been connected to the pole 89. FIG. 6 illustrates that the output from the PLL 62 and applied to the input of the multiplier 72 comprises a constant amplitude phase or frequency modulated signal. A similar signal is present on the output 76 of the multiplier 72 and this is supplied to the PA module 40. In the case of GSM the output signal is a constant-envelope signal but in the case of the non-GSM modulations the voltage, shown in FIG. 4B, varies the supply voltage of the PA module 40 causing the output to have the required non-constant envelope.

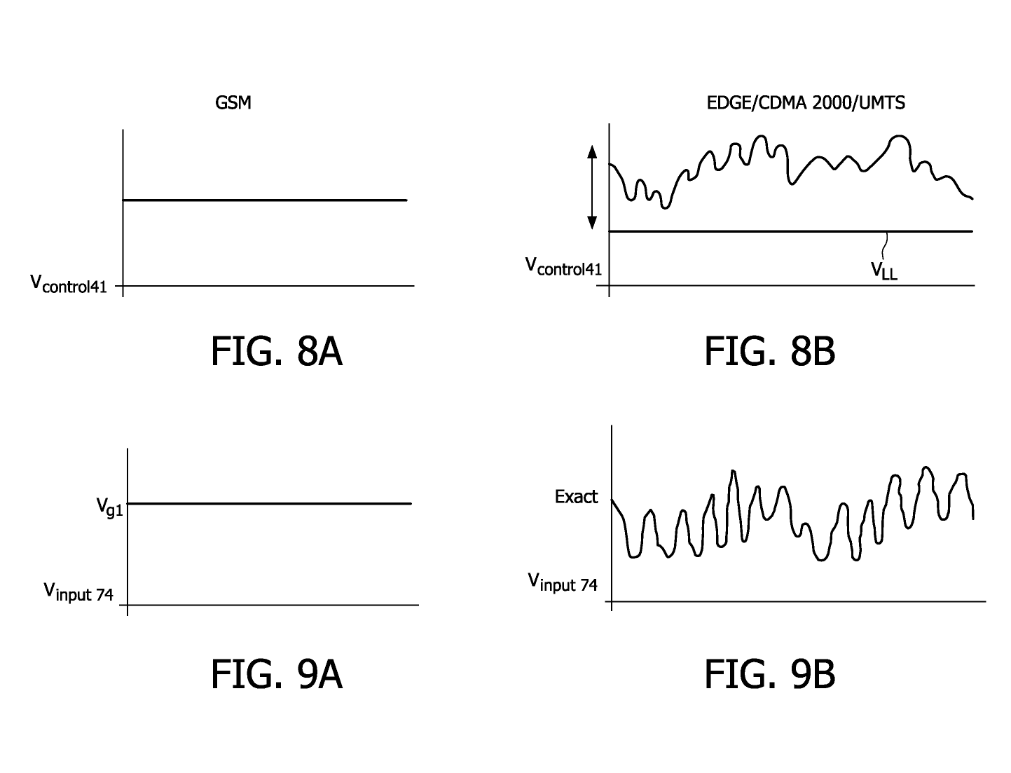

FIGS. 8A and 8B illustrate the voltage on the control input 41 of the power amplifier module 40 for GSM and non-GSM modulations, respectively, for small signal polar with envelope tracking. In the case of GSM, FIG. 8A, the voltage is a DC which is a function of the average power. However for non-GSM modulations the voltage varies with the amplitude component of the modulating signal relative to a predetermined lower level V_{LL}. Referring to FIGS. 9A and 9B which show the signals at the second input 74 of the multiplier 72. In FIG. 9A the signal is the DC voltage V_{g1} whereas in FIG. 9B the signal is substantially the exact replica of the amplitude component R derived from the envelope extract block 60. This signal is derived by the first amplitude control circuit 78 and is a more precise or aggressive copy of the amplitude component R than would be provided by the second amplitude control circuit 120.

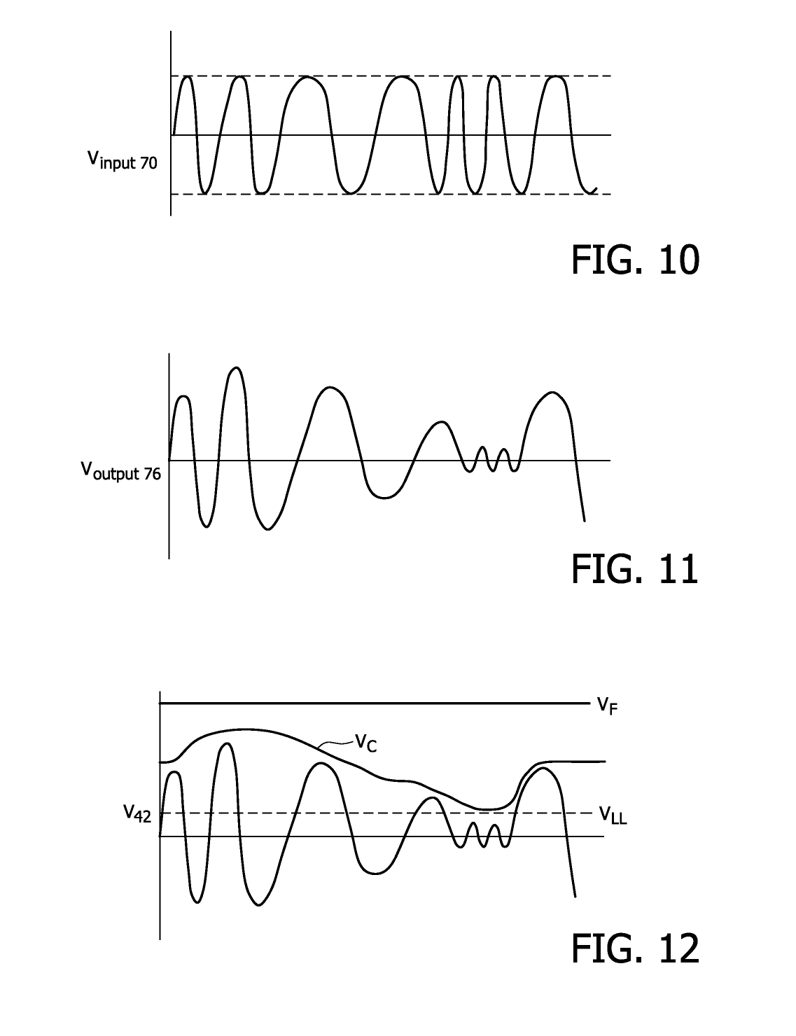

FIG. 10 which illustrates the constant envelope phase or frequency modulated signal applied by the PLL 62 to the first input 70 of the multiplier 72 is, for the convenience of illustration, a duplicate of the signal shown in FIG. 6. FIG. 11 illustrates the fully modulated signal on the output of the multiplier 76. The amplitude modulation corresponds with the exact replica of the amplitude component derived by the amplitude control circuit 78.

FIG. 12 illustrates the output of the power amplifier module 40. When the amplitude of the fully modulated signal is less than its peak value, the control voltage V_{c} is made corresponding less than its peak value V_{F}. However, if the amplitude of the fully modulated signal is very small, the control voltage is maintained at the predetermined lower level V_{LL}, to keep the power amplifier operating in a consistent manner. The control voltage V_{c} is thus a less precise version of the amplitude component shown in FIG. 4B, so that power amplifier voltage is greater than, but generally tracks, the amplitude component.

In order to facilitate an understanding of the various operating modes reference will be made to the truth table shown below. The footnotes beneath the table explain the abbreviations used. Whilst it might ideally be desirable to use polar modulation, in all circumstances, the table describes what operating modes will provide the highest efficiency, given the current state of the art.

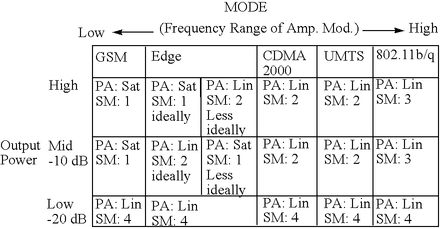

Sat = Saturated
Lin = Linear
SM = Supply Mode
SM: 1 = Large Signal Polar
SM: 2 = Envelope tracking and small signal polar
SM: 3 = Slow variation with average carrier power (efficiency control)
SM: 4 = Do nothing-fixed low value V_{LL} (FIG 12).

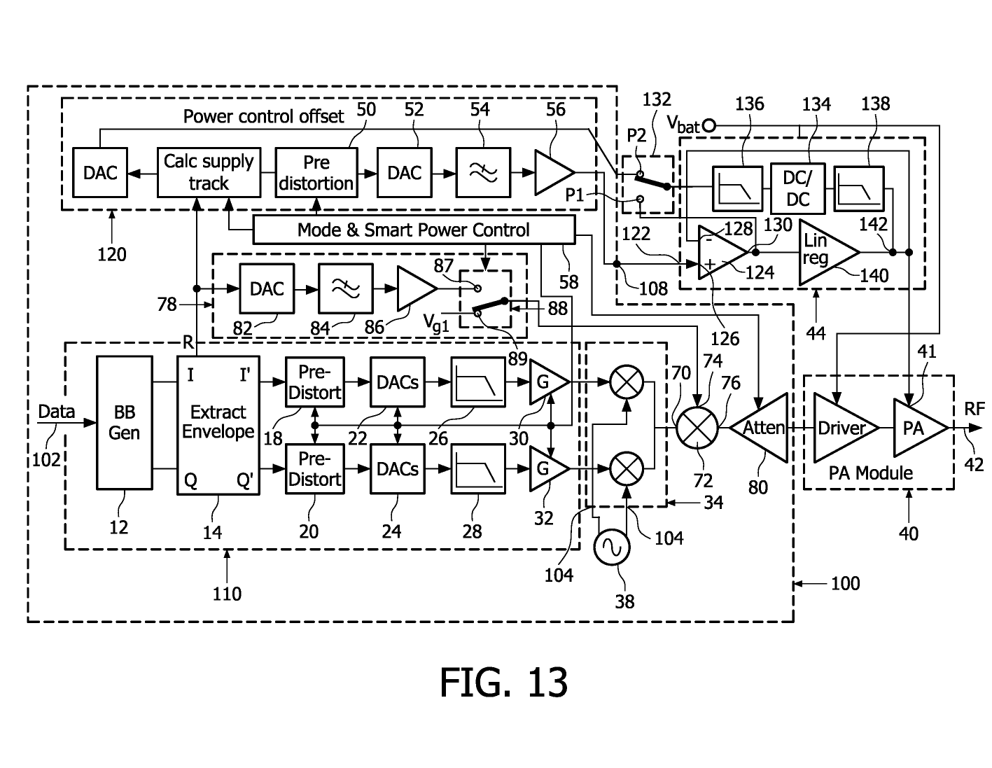

Referring to FIG. 13, this illustrates an embodiment of the present invention employing a hybrid Cartesian/polar transmitter architecture. This embodiment differs from the block schematic circuit shown in FIG. 1 in that the output from the quadrature modulation means 34 is coupled to a first input 70 of a multiplier 72, a second input 74 of which is coupled to an output of a first amplitude control circuit 78 of the type illustrated in, and described with reference to, FIG. 2. An output 76 of the multiplier 72 is connected by way of an attenuator 80 to the PA module 40.

A second amplitude control circuit 120 is coupled to the hybrid supply modulator 44 which in turn is connected to the control input 41 of the PA module 40. As this arrangement is the same as shown in FIG. 2, in the interests of brevity its construction and operation will not be repeated.

The invention has been conceived in the context of the radio transmitter in cellular radio handsets needing to provide the best possible power efficiency when working on the existing 2G and the latest 2.5G and 3G standards. It is of potential application to any other radio transmitter scenarios in which the need to operate on any one of a number of different standards or at different RF output power levels has traditionally led to irreconcilable constraints on choosing what constitutes the best architecture for the task.

In the present specification and claims the word “a” or “an” preceding an element does not exclude the presence of a plurality of such elements. Further, the word “comprising” does not exclude the presence of other elements or steps than those listed.

The use of any reference signs placed between parentheses in the claims shall not be construed as limiting the scope of the claims.

From reading the present disclosure, other modifications will be apparent to persons skilled in the art. Such modifications may involve other features which are already known in the design, manufacture and use of radio transmitters and component parts therefor and which may be used instead of or in addition to features already described herein.

1. A method of operating a multi-mode transmitter in which an input signal is modulated independently of controlling the drive of a power amplifying means.

2. A method as claimed in claim 1, wherein the modulation is one of constant envelope modulation and envelope tracking modulation.

3. A method as claimed in claim 1, comprising separating amplitude information from phase information in the input signal to be transmitted, using the phase information to produce a modulated constant envelope real signal at the frequency of the transmitter, and using the amplitude information to amplitude modulate the constant envelope signal, wherein in that the amplitude modulation is applied in a selected one of two modes, in a first of the two modes the amplitude modulation is applied as a low level signal prior to power amplification in the power amplifying means operating in a linear envelope tracking mode in which an envelope tracking signal derived from the amplitude information is applied to the power amplifying means at high level and in a second of the two modes the constant envelope real signal is multiplied by a fixed voltage signal prior to being applied to the power amplifying means operating in a saturation mode and the amplitude modulation is applied to the power amplifying means at high level, the selection of the first or second of the two modes being dependent on the characteristics and required output power of the signal being transmitted.

4. A method as claimed in claim 3, wherein in response to the output power being lower than a predetermined level the amplitude signal is applied in the first of the two modes and in response to the output power being greater than a predetermined level the amplitude signal is applied in the second of the two modes.

5. A method as claimed in claim 3, wherein the first of the two modes of modulation comprises envelope tracking in which the power amplifying means is operated linearly and the second of the two modes of modulation comprises polar modulation in which the power amplifying means is operated in saturation.

6. A method as claimed in claim 3, comprising producing 1 the modulated constant envelope real signal using a phase locked loop.

7. A method as claimed in claim 3, comprising producing the modulated constant envelope real signal using a dual-point modulation arrangement within a phase locked loop.

8. A method as claimed in claim 1, comprising attenuating the modulated signal applied to the power amplifying stage.

9. A method as claimed in in claim 1, comprising controlling the drive by varying a power supply voltage to the power amplifying means.

10. A method as claimed in claim 9, wherein at frequencies above a predetermined crossover frequency, the power supply voltage is predominantly supplied by way of a linear regulator.

11. A method as claimed in claim 10, wherein at frequencies below a predetermined crossover frequency, the power supply voltage is predominantly supplied by way of a DC/DC converter.

12. A multi-mode transmitter comprising an input for an input signal, modulating means for producing a modulated signal, power amplifying coupled to the modulating means, the PA means having a control voltage input, and means for providing a PA control voltage to be applied to the control voltage input independently of the modulating means.

13. A transmitter as claimed in claim 12, wherein the modulating means is adapted for producing one of constant envelope modulation and envelope tracking modulation.

14. A transmitter as claimed in claim 12, comprising means for deriving separately phase and amplitude components present in an input signal, means for producing from the phase component information a modulated constant envelope real signal at the operating frequency of the transmitter, first means for producing from the amplitude component information a first amplitude signal comprising a substantially faithful representation of the amplitude component of the input signal, multiplying means having a first input for the real signal and a second input coupled in a first optional condition to the first means for applying the first amplitude signal amplitude modulation of the real signal for envelope tracking or in a second optional condition to means for setting the second input to a fixed voltage for polar modulation, the multiplying means having an output coupled to the power amplifying means, second means for producing a second amplitude signal from the amplitude component information, a power control voltage generating means having a control input coupled to receive the second amplitude signal, the power control voltage generating means having an output coupled to the control input of the power amplifying means, said second means in the first optional condition providing a power control signal enabling envelope tracking to be applied to the power amplifying means working in a linear mode or in the second optional condition providing an optionally pre-distorted power control voltage for polar modulation when the power amplifying means is operating in saturation, and control means for controlling the first and second means to operate in the first optional condition for envelope tracking and a second optional condition for polar modulation dependent on the characteristics and required output power of the signal being transmitted.

15. A transmitter as claimed in claim 14, comprising attenuating means coupled between the multiplying means and the power amplifying means, and in that the control means controls the attenuating means in the second of the optional conditions to inhibit applying attenuation to the output from the multiplying means.

16. A transmitter as claimed in claim 14, wherein the means for producing the constant envelope real signal comprises a fractional-N phase locked loop.

17. A transmitter as claimed in claim 14, wherein the means for producing the constant envelope real signal comprises a dual-point modulation arrangement within a phase locked loop.

18. A transmitter as claimed in in claim 14, wherein the first means includes means for deriving the amplitude signal as an analogue representation of envelope information from the amplitude component information and selector means responsive to the control means for selecting either the analogue representation of the envelope information for operation in the first optional condition or the fixed voltage for operating in the second optional condition.

19. A transmitter as claimed in claim 14, comprising power control voltage generating means comprising a DC/DC converter having an output coupled to the control input of the power amplifying means.

20. A transmitter as claimed in claim 19, wherein the power control voltage generating means further comprises a linear regulator coupled in parallel with the DC/DC converter, and wherein means are provided for controlling the power control voltage generating means so that below a predetermined crossover frequency the DC/DC converter provides a control voltage to the control input of the power amplifying means and above the predetermined crossover frequency the linear regulator provides the control voltage to the said control input.

21. A transmitter as claimed in claim 14, wherein the control means is responsive to the characteristics and required output power of the signal being transmitted to switch from one of the optional conditions to another of the optional conditions.
